(19) United States
(12) Patent Application Publication
(10) Pub. No.: US 2025/0285456 A1
(43) Pub. Date: Sep. 11, 2025

(54) IMAGE ANALYSIS DEVICE, STORAGE MEDIUM THAT STORES IMAGE ANALYSIS PROGRAM, AND MICROSCOPE DEVICE

(71) Applicant: Hitachi, Ltd., Tokyo (JP)

(72) Inventors: Hiroyuki YAMAMOTO, Tokyo (JP); Isao KITAGAWA, Tokyo (JP)

(21) Appl. No.: 19/034,159

(22) Filed: Jan. 22, 2025

(30) Foreign Application Priority Data
Mar. 6, 2024 (JP) 2024-033955

(51) Int. Cl. G06V 20/69; G06T 5/90; G06T 7/66

(52) U.S. Cl. CPC G06V 20/698; G06T 5/90; G06T 7/66; G06T 2207/10056

(57) ABSTRACT

An image analysis device analyzes an arrangement of objects in a microstructure image of a composition and includes an ideal convergence distance calculation unit configured to calculate an ideal convergence distance indicating a distance between the objects in an ideal state of the arrangement of the objects. A convergence calculation processing unit is configured to generate, for each of a plurality of connection distances, a plurality of remaining groups in each of which the objects are connectable to each other at the connection distance, and connection distance correlation information is generated indicating a correlation between a group number of the generated remaining groups and the connection distance. A heterogeneity index is calculated indicating a bias in the arrangement of the objects based on the ideal convergence distance and the connection distance correlation information; and display data is output and displayed according to the heterogeneity index.

### CLAIM OF PRIORITY

The present application claims priority from Japanese Patent Application JP 2024-033955 filed on Mar. 6, 2024, the content of which are hereby incorporated by references into this application.

### BACKGROUND OF THE INVENTION

### 1. Field of the Invention

The present invention mainly relates to a technique for analyzing a microstructure image of a composition such as a material.

### 2. Description of Related Art

At present, analysis for a composition containing an object is performed using a microstructure image of the composition. For example, analysis for functional materials such as a metal, a ceramic, or a resin is performed. In such functional materials, a material property changes depending on a microstructure of the material, and it is extremely important to control the microstructure. In order to control the microstructure of the material, it is important to quantitatively evaluate the microstructure. Accordingly, in general, a feature of the microstructure is digitized by image processing based on an observation image obtained by using an optical microscope or an electron microscope, and the data is analyzed in association with the material property, thereby obtaining guidelines for understanding a property expression mechanism and improving the property.

Among the functional materials, a plurality of components or compounds are mixed in one material, and in these materials, dispersibility of objects in a composition such as included components is often regarded important as a factor that strongly affects the material property. Typical examples include dispersibility of a fine precipitate in a steel material and dispersibility of a heterogeneous polymer in a functional polymeric material produced in a kneading process. Therefore, an image processing technique capable of appropriately quantifying dispersibility of a component included in a material microstructure becomes important.

Accordingly, a method for evaluating dispersibility of a microstructure based on a microstructure image has been proposed. As a general method applied from the past, there is a compartmentalization method in which a microstructure image is divided into compartments each having a certain size, a feature is extracted from a distribution of areas or the like of objects included in each of the compartments, and an index of the dispersibility is calculated.

For example, in PTL 1, a method for more precisely evaluating dispersibility from a micro scale to a macro scale based on a compartmentalization method is proposed. According to the method in PTL 1, it is shown that a feature of each scale is calculated while changing a size of a compartment obtained by dividing an image, and a dispersibility index for the entire image can be calculated based on a change in feature dependency on the size of the compartment.

### CITATION LIST

### Patent Literature

PTL 1: JP2015-7542A

### SUMMARY OF THE INVENTION

Here, PTL 1 shows an effective method for evaluating the dispersibility, but the method is based on the compartmentalization method, and thus a difference in positional relations of objects is not expressed in the divided compartment. In Examples described in PTL 1, the image is divided by a division number of 2ⁿ×2ⁿ (n: natural number) for convenience of making the size of the compartment constant, and thus there are restrictions on an input image and a division degree of the size of the compartment. In this regard, PTL 1 discloses that the division number is not limited to 2ⁿ×2ⁿ, but does not describe a specific content, and there is a problem that the compartments cannot be divided by a division number that is an integer depending on a pixel size and an aspect ratio of the image, and the analysis is difficult.

Therefore, an object of the invention is to make it possible to grasp a bias in an arrangement such as dispersibility or heterogeneity of objects in a microstructure image having any size.

In the invention, a heterogeneity index indicating a bias in objects in a microstructure image is calculated according to a distance between the objects. That is, a heterogeneity index indicating a bias in an arrangement of objects is calculated based on an ideal convergence distance in an ideal state of the arrangement of the objects and connection distance correlation information indicating a relation between a connection distance of the objects and a group number of remaining groups generated according to the connection distance.

More specifically, an image analysis device for analyzing an arrangement of objects in a microstructure image of a composition includes: an ideal convergence distance calculation unit configured to calculate an ideal convergence distance indicating a distance between the objects in an ideal state of the arrangement of the objects; a convergence calculation processing unit configured to generate, for each of a plurality of connection distances, a plurality of remaining groups in each of which the objects are connectable to each other at the connection distance, and generate connection distance correlation information indicating a correlation between a group number of the generated remaining groups and the connection distance; a heterogeneity index calculation unit configured to calculate a heterogeneity index indicating a bias in the arrangement of the objects based on the ideal convergence distance and the connection distance correlation information; and an output unit configured to output display data according to the heterogeneity index.

An exemplary image analysis device according to the present disclosure is preferably a device including a computer that stores and executes an image analysis program. Further, the image analysis device may be connected to an input interface through which a user can input information necessary for calculation, and a display device that displays a calculation result to the user. The image analysis device may be connected to an imaging device that communicates data with the outside via a network and that observes a material microstructure via the network, for example, an optical microscope or an electron microscope.

The invention further provides an image analysis program that causes the image analysis device to function as a computer, and a storage medium that stores the image analysis program. The invention also provides an image analysis method executed by the image analysis device.

According to the invention, it is possible to quantitatively evaluate a bias in an arrangement of objects in a microstructure image more precisely, and to grasp dispersibility and heterogeneity or concentration and homogeneity of the objects.

### BRIEF DESCRIPTION OF THE DRAWINGS

FIG. 1 is a functional block diagram of an image analysis device according to Embodiment 1;

FIG. 2A is a schematic diagram of a binarized microstructure image according to Embodiment 1;

FIG. 2B is a diagram schematically showing an example of a connection distance between objects in the microstructure image according to Embodiment 1;

FIG. 3 is a diagram showing a coordinate area list used in Embodiment 1;

FIG. 4 is a diagram showing a group number list used in Embodiment 1;

FIG. 5A is a diagram showing a change in connection state between objects according to a connection distance in Embodiment 1;

FIG. 5B is a diagram showing a change in connection state between objects according to a connection distance in Embodiment 1;

FIG. 5C is a diagram showing a change in connection state between objects according to a connection distance in Embodiment 1;

FIG. 6 is a diagram schematically showing a group convergence graph according to Embodiment 1;

FIG. 7 shows diagrams showing a concept of an ideal convergence distance in an object arrangement according to Embodiment 1;

FIG. 8 is a diagram showing an example of a method of calculating a heterogeneity index according to Embodiment 1;

FIG. 9 is a diagram showing heterogeneity information used in Embodiment 1;

FIG. 10 is a hardware configuration diagram of the image analysis device according to Embodiment 1;

FIG. 11 is a flowchart showing an image analysis processing flow according to Embodiment 1;

FIGS. 12A to 12F are diagrams each showing an example of an analysis result according to Embodiment 1;

FIG. 13 is a diagram showing a relation between the heterogeneity index and a variation range of particle coordinates according to Embodiment 1;

FIGS. 14A to 14D are diagrams each showing another example of the analysis result according to Embodiment 1;

FIG. 15 is a diagram showing calculation for an object-to-object distance according to Embodiment 2; and

FIG. 16 is a diagram showing a GUI screen according to Embodiment 1 and Embodiment 2.

### DESCRIPTION OF EMBODIMENTS

Hereinafter, embodiments of the present disclosure will be described, but the invention is not limited to only descriptions of the present embodiment or the embodiments to be described later, and a configuration obtained by appropriately combining, within a scope of knowledge of a person skilled in the art, elemental techniques to be disclosed or taught in the present embodiment and the embodiments is also included in the scope of the invention.

In the present embodiment, a heterogeneity index indicating a bias in an arrangement of objects contained in a composition is calculated. For this purpose, in the present embodiment, the heterogeneity index indicating a bias in objects in a microstructure image acquired by imaging a cross section of a material or the like is calculated according to a distance between the objects. In the present embodiment, the heterogeneity index is calculated based on an ideal convergence distance in an ideal state of an arrangement of the objects, and connection distance correlation information indicating a correlation between a connection distance of the objects and a group number of remaining groups, for example, a group convergence polygonal line 50.

In the present application, the composition contains an object, and includes a material such as a metal, a living body such as a human body, a living tissue, a stratum, and a microstructure. The object is a substance included in the microstructure, includes a particle, an element, a component, and a phase, and can be distinguished from other portions in a binary image. The heterogeneity index indicates a degree of difference (bias) from the ideal state, and is an index with which dispersibility, non-uniformity or heterogeneity, and unevenness of objects can be grasped. Here, the bias can also be expressed as a variation. In the invention, a homogeneity index indicating a balance of an arrangement opposite to the bias may be used.

Hereinafter, embodiments specifically showing the present embodiment will be described.

### Embodiment 1

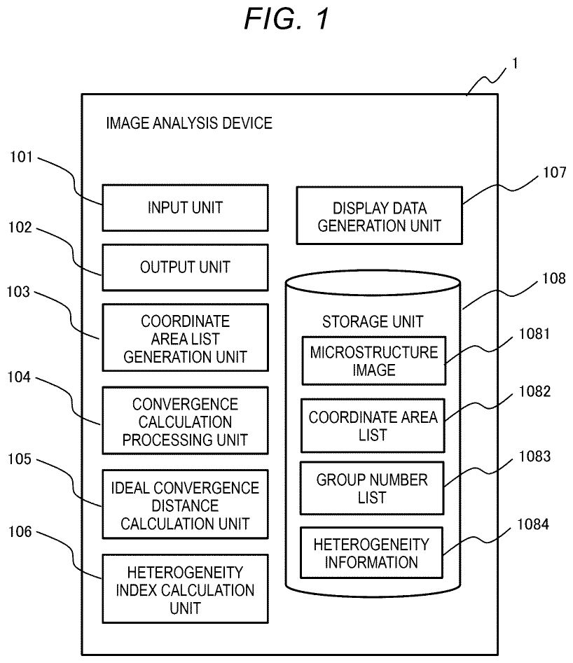

First, FIG. 1 is a functional block diagram of an image analysis device 1 according to Embodiment 1. As shown in FIG. 1, the image analysis device 1 includes an input unit 101, an output unit 102, a coordinate area list generation unit 103, a convergence calculation processing unit 104, an ideal convergence distance calculation unit 105, a heterogeneity index calculation unit 106, a display data generation unit 107, and a storage unit 108. Hereinafter, each functional block will be described using a schematic diagram of a microstructure image.

First, the input unit 101 receives a microstructure image to be processed in Embodiment 1. The input unit 101 receives various instructions from a user. A plurality of input units 101 may be prepared, and the microstructure image and the instructions may be separately received.

The output unit 102 outputs a calculated heterogeneity index and display data generated based on the heterogeneity index.

The coordinate area list generation unit 103 processes a color tone and a contrast of the microstructure image (RGB image or grayscale image) received by the input unit 101, and generates a binarized microstructure image 1081. At this time, in an original image before analysis, a shape of an object to be analyzed is generally amorphous. Accordingly, the coordinate area list generation unit 103 performs, for example, circular approximation corresponding to an area of each object (amorphous) to generate a binary image.

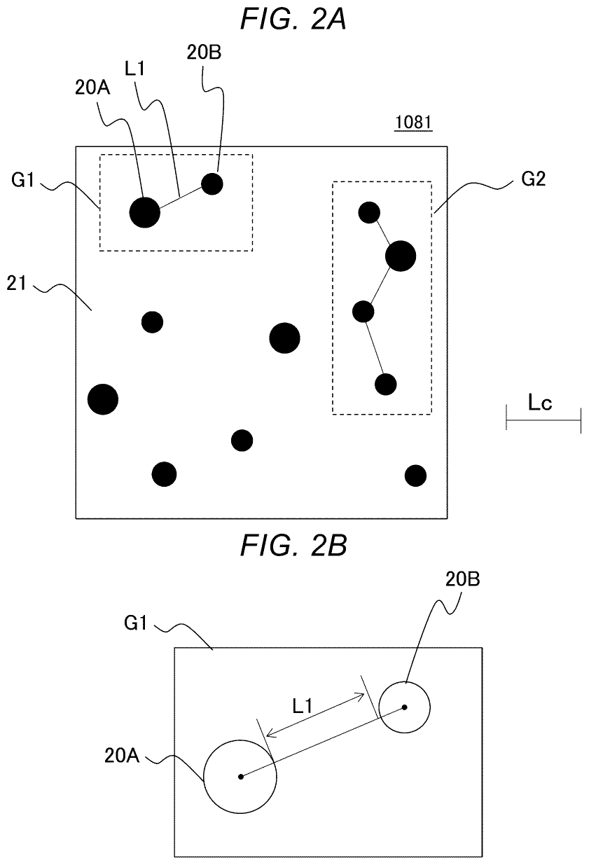

FIG. 2A shows a schematic diagram of the binarized microstructure image 1081. In FIG. 2A, the microstructure image 1081 includes two types of components having different luminance levels, and objects 20 (denoted by 20A and 20B in FIG. 2A) are arranged in a background microstructure 21. Further, the coordinate area list generation unit 103 generates, using the binary image, a coordinate area list 1082 in which a position of a center of gravity and an area of each of the plurality of objects 20 on the image are recorded.

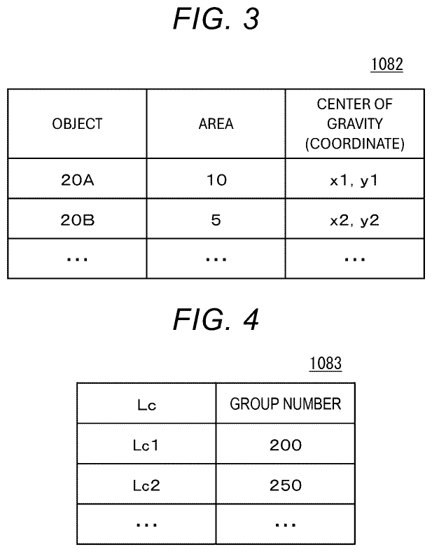

Here, the coordinate area list 1082 used in Embodiment 1 is shown in FIG. 3. The coordinate area list 1082 is stored in the storage unit 108, and as shown in FIG. 3, the area and the center of gravity of each object are recorded. Since the area is used to determine an object-to-object distance L1, the area may be an area of the object or may be a processing area such as an image area. Similarly, as long as the center of gravity can be used to determine the object-to-object distance L1, it does not matter what coordinate system is used for the center of gravity.

In FIG. 2A, a generated group G1 and a generated group G2 are schematically shown. The generation for these groups will be described later.

The convergence calculation processing unit 104 calculates a distance between the objects 20 (object-to-object distance) using the coordinate area list 1082. In addition, the convergence calculation processing unit 104 sets a predetermined connection distance Lc and compares a magnitude of the Lc with the object-to-object distance between the objects. As an example, FIG. 2A schematically shows the object-to-object distance L1 between the objects 20A and 20B.

As shown in FIG. 2B, in Embodiment 1, the object-to-object distance (L1 in FIG. 2B) is a distance in consideration of the area of each object. That is, a distance between ends of two objects, for example, a distance obtained by subtracting an equivalent circle radius from a center-to-center distance is set as the object-to-object distance. However, a length of a line segment connecting centers of the objects or the centers of gravity of the objects with a straight line may be set as the object-to-object distance L1. That is, the distance between the centers or the distance between the centers of gravity of the objects 20 can be used as the object-to-object distance L1.

The convergence calculation processing unit 104 compares the object-to-object distance L1 between the objects and the connection distance Lc. When the L1 is shorter than the Lc, the convergence calculation processing unit 104 sets the two corresponding objects as one remaining group. In the example in FIG. 2A, the group G1 and the group G2 are generated. In this way, the convergence calculation processing unit 104 performs comparison between the object-to-object distance L1 and the connection distance Lc and grouping.

Here, the convergence calculation processing unit 104 performs the comparison between the object-to-object distance L1 and the connection distance Lc and the grouping of the objects for an object combination. The object combination may be all objects in the microstructure image or may be objects in a partial image of the microstructure image. Then, the convergence calculation processing unit 104 counts a group number obtained using the set connection distance Lc, and records the group number in a group number list 1083. For an object that cannot be formed into a group, even one object is set as an independent group. Here, the object that cannot be formed into a group is an object for which an object-to-object distance between the target object and another object is larger than the connection distance Lc. As described above, the convergence calculation processing unit 104 groups objects within the range of the connection distance Lc.

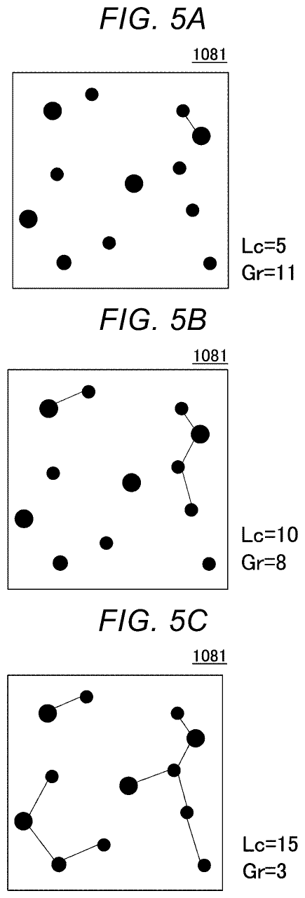

Subsequently, the convergence calculation processing unit 104 sets the connection distance Lc whose magnitude changes, counts the group number corresponding to the newly set connection distance Lc by a procedure the same as that described above, and records the group number in the group number list 1083. Here, FIG. 4 shows the group number list 1083 used in Embodiment 1. The group number list 1083 shows the group number for each connection distance Lc. In an example in FIG. 4, since the connection distance is Lc1<Lc2, the group number in a range of Lc2 is smaller. Specific examples of a change in connection state of the objects, including a change in group number that changes according to the connection distance Lc, will be described with reference to FIGS. 5A to 5C.

In FIG. 5A, the connection distance Lc is 5, and a group number Gr is 11. This connection distance Lc is the shortest among those in FIGS. 5A to 5C, and the group number Gr is the largest. Then, as the connection distance Lc is increased to Lc=10 in FIG. 5B and Lc=15 in FIG. 5C, the number of objects connected to each other increases. As a result, the group number Gr decreases to Gr=8 in FIG. 5B and Gr=3 in FIG. 5C.

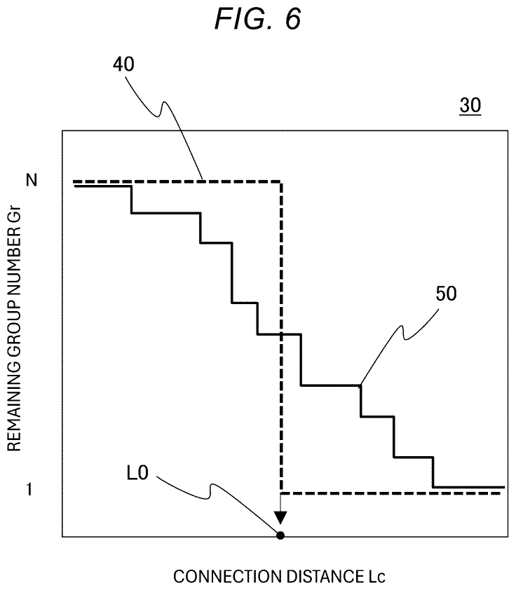

In this way, the convergence calculation processing unit 104 counts the change in group number of the objects while sequentially changing the connection distance Lc, and specifies connection distance correlation information indicating a correlation therebetween. That is, as described above, the convergence calculation processing unit 104 generates, for each of a plurality of connection distances Lc, a plurality of remaining groups in which the objects 20 can be connected to each other at the connection distance Lc. Then, the connection distance correlation information indicating a correlation between a group number of the generated remaining groups and a corresponding connection distance is generated. In Embodiment 1, the group convergence polygonal line 50 indicating dependency of the group number on the connection distance Lc and a group convergence graph 30 including the group convergence polygonal line 50 are generated as the connection distance correlation information. FIG. 6 shows a schematic diagram of the group convergence graph 30. In FIG. 6, in the group convergence graph 30, a vertical axis represents the remaining group number (Gr), and a horizontal axis represents the connection distance (Lc). The remaining group number indicates a group number of objects generated using a corresponding connection distance. The group convergence graph 30 includes an ideal convergence line 40 and the group convergence polygonal line 50. The group convergence polygonal line 50 is an example of the connection distance correlation information indicating the correlation between the connection distance of the objects and the group number of object groups generated according to the connection distance.

The ideal convergence line 40 indicates a distance between objects in an ideal state of an arrangement of the objects, and the heterogeneity index is calculated by comparing the ideal convergence line 40 with the group convergence polygonal line 50. The ideal convergence line 40 will be described later. The group convergence polygonal line 50 is generated by the convergence calculation processing unit 104 while changing the connection distance Lc as described above. In the group convergence polygonal line 50 in FIG. 6, the remaining group number Gr decreases stepwise every time the connection distance Lc increases. More specifically, it is shown that an increase width of the connection distance Lc is not constant, but the increase width may be constant.

Further, by reducing the increase width of the connection distance Lc, a shape of the polygonal line becomes finer and smoother. Accordingly, by reducing the increase width, the correlation between the connection distance Lc and the remaining group number Gr can be grasped more precisely. However, the smaller the increase width is, the greater a processing load of the convergence calculation processing unit 104 becomes. Therefore, the increase width of the connection distance Lc can be determined in consideration of a balance between accuracy of the correlation and the processing load. Further, the increase width of the connection distance Lc may be changed for each processing.

As an example of this, the increase width of the connection distance Lc is reduced in a location in which the remaining group number Gr decreases more. For this purpose, the convergence calculation processing unit 104 may initially set the increase width of the connection distance Lc to be large, and when a decrease number of the remaining group number Gr is larger than a predetermined value, may subdivide the increase width of the connection distance Lc and count the remaining group number Gr again.

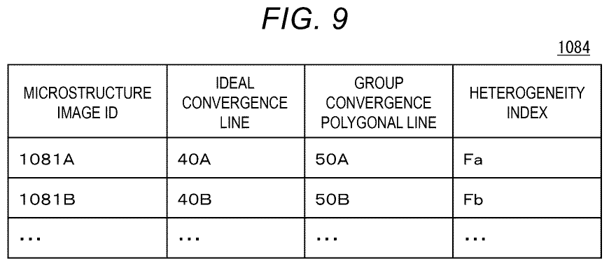

As described above, the connection distance correlation information represented by the group convergence polygonal line 50 indicates a set of group numbers for respective connection distances. As described above, when the group convergence polygonal line 50 is generated, the convergence calculation processing unit 104 registers the group convergence polygonal line 50 in heterogeneity information 1084 of the storage unit 108. The heterogeneity information 1084 will be described later with reference to FIG. 9.

Next, the ideal convergence line 40 that is compared with the group convergence polygonal line 50 to calculate the heterogeneity index will be described. The ideal convergence line 40 is calculated by the ideal convergence distance calculation unit 105. For this purpose, the ideal convergence distance calculation unit 105 calculates the number and a total area of objects included in the microstructure image 1081 based on the coordinate area list 1082. Then, the ideal convergence distance calculation unit 105 calculates an object-to-object distance (ideal convergence distance L0) in the ideal state of the arrangement of the objects based on the number and the total area of the objects.

Here, the ideal state in Embodiment 1 indicates a state in which the objects 20 are substantially uniformly dispersed. However, the ideal state is not limited thereto, and may be a state designated by a user. For example, the target objects 20 may be arranged substantially uniformly in the vicinity of a center of the microstructure image 1081, or may be arranged according to sizes of the objects 20. In the latter case, the more the objects 20 are, the closer the objects 20 are arranged to the center, and regions indicated by the objects 20 may be arranged substantially evenly in the microstructure image 1081.

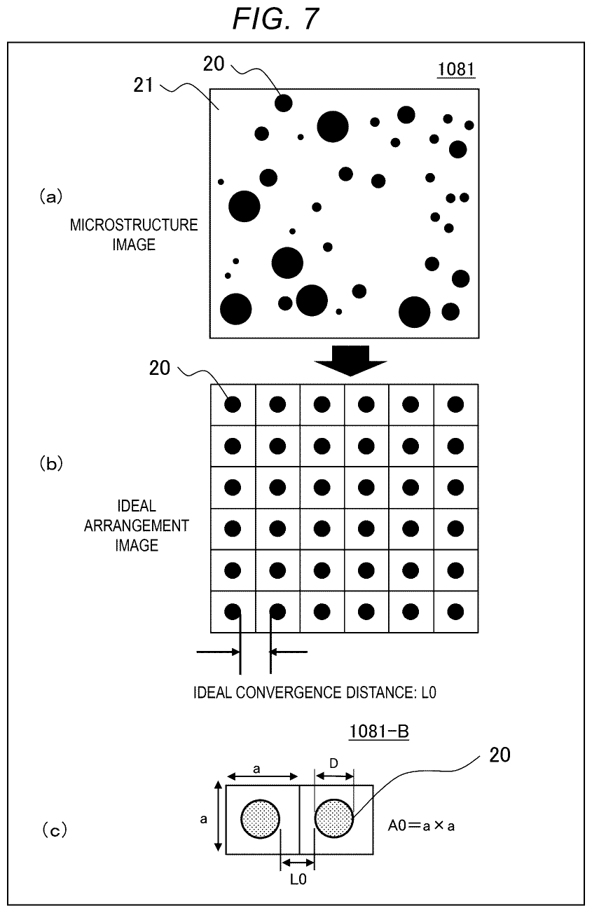

Here, a concept of the ideal convergence distance L0 in Embodiment 1 will be described with reference to FIG. 7. First, a number N and a total area Sa of the objects 20 can be calculated based on the microstructure image 1081 that is a binary image of a microstructure to be analyzed shown in (a) in FIG. 7. Then, a state in which the N objects (circles) have equal areas and are arranged at equal intervals while maintaining the total area Sa is the ideal state. That is, as shown in (b) in FIG. 7, an ideal arrangement image shows this ideal state. When a distance between adjacent objects at this time is the ideal convergence distance L0, the ideal convergence distance calculation unit 105 can calculate the ideal convergence distance L0 according to the following (Formula 1).

$$L 0 = \sqrt{W \cdot H / N} - 2 \sqrt{\frac{S a}{N π}} \qquad ( Formula 1 )$$

Here, W represents a width of the image, H represents a height of the image, N represents the number of the objects, Sa represents the total area of the objects, and IT represents a circumference ratio. According to (Formula 1), the ideal convergence distance L0 is uniquely determined regardless of subjectivity. In the ideal arrangement image in (b) in FIG. 7, N=36 objects are shown to be arranged in a 6×6 arrangement in an easy-to-understand manner, but in an actual microstructure, the number N is not necessarily a perfect numerical value. Even in this case, the ideal convergence distance L0 can be calculated using (Formula 1).

The first term on the right side of (Formula 1) is a square root of an area A0 obtained by dividing an area of the entire image by the number N, in other words, the first term represents a length a of one side of an average area to be owned by each object when the area is assumed to be a square (see (c) in FIG. 7).

The second term on the right side of (Formula 1) represents an equivalent circle diameter D of the object. Accordingly, the A0 can be calculated even when N is not n×n (n: natural number), and the object-to-object distance L0, that is, the ideal convergence distance L0 can be obtained based on the A0. As a result, the ideal convergence line 40 in FIG. 6 is specified. The ideal convergence distance calculation unit 105 registers the ideal convergence line 40 calculated in this manner in heterogeneity information 1084 of the storage unit 108.

Next, processing in the heterogeneity index calculation unit 106 will be described. As preprocessing of the processing in the heterogeneity index calculation unit 106, the ideal convergence distance calculation unit 105 specifies the ideal convergence line 40. That is, in the group convergence graph 30 shown in FIG. 6, when dependency of a group number on the connection distance Lc in the ideal dispersion state in which the objects 20 are uniformly arranged is plotted, the group number Gr changes stepwise, converging from N to 1 at L0. That is, the ideal convergence line 40 shown in FIG. 6 is specified.

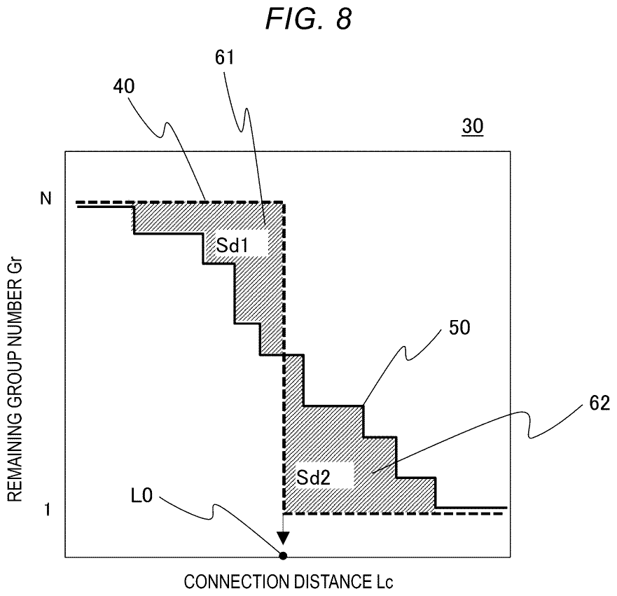

Then, the heterogeneity index calculation unit 106 calculates the heterogeneity index using a relation between the ideal convergence line 40 and the group convergence polygonal line 50. For this purpose, the heterogeneity index calculation unit 106 compares the ideal convergence line 40 and the group convergence polygonal line 50. For example, the heterogeneity index calculation unit 106 compares the ideal convergence line 40 and the group convergence polygonal line 50 and calculates a difference therebetween. An example of a method of calculating the heterogeneity index according to Embodiment 1 will be described with reference to FIG. 8.

The heterogeneity index calculation unit 106 calculates a heterogeneity index F by dividing an area Sd1+Sd2 of deviations 61 and 62 (hatched regions in FIG. 8) between the ideal convergence line 40 and the group convergence polygonal line 50 in FIG. 8 by the number N of the objects 20. That is, the heterogeneity index is calculated using the following (Formula 2).

$$F = ( Sd 1 + Sd 2 ) / N \qquad ( Formula 2 )$$

That is, the heterogeneity index F expresses that, as the deviation between the ideal convergence line 40 and the group convergence polygonal line 50 increases, a composition indicated by the microstructure image 1081 is biased in the objects 20, that is, is deviated from a use state.

The heterogeneity index F is determined using the area determined by comparing the ideal convergence line 40 and the group convergence polygonal line 50. However, information other than the area may be used to determine the heterogeneity index F. For example, an interval (difference distance) between the ideal convergence line 40 and the group convergence polygonal line 50 may be used. As the interval, a representative value such as a maximum value, an average value, or a median value of the interval can be used. In this case, the heterogeneity index calculation unit 106 specifies intervals for the respective remaining group numbers Gr and calculates a representative value of each of the intervals. Further, the heterogeneity index calculation unit 106 may use a cumulative value of the intervals for the respective remaining group numbers Gr.

Then, the heterogeneity index calculation unit 106 registers the heterogeneity index F in the heterogeneity information 1084 of the storage unit 108. Here, the heterogeneity information 1084 used in Embodiment 1 will be described with reference to FIG. 9. The heterogeneity information 1084 is information related to heterogeneity in an arrangement of the objects 20 for each microstructure image to be analyzed. For this purpose, the heterogeneity information 1084 includes items of an ideal convergence line, a group convergence polygonal line, and a heterogeneity index for each microstructure image ID.

The microstructure image ID is an item for identifying a microstructure image to be analyzed, and is registered when the convergence calculation processing unit 104 registers the group convergence polygonal line 50 or when the input unit 101 receives the microstructure image 1081.

Information indicating the ideal convergence line 40 generated by the ideal convergence distance calculation unit 105 is registered in the ideal convergence line. The ideal convergence line 40 to be registered does not need to have a line (graph) shape, but only needs to indicate the correlation between the connection distance Lc and the remaining group number Gr. For example, the ideal convergence line 40 can be implemented by numerical data in which the connection distance Lc and the remaining group number Gr are associated with each other.

Information indicating the group convergence polygonal line 50 generated by the convergence calculation processing unit 104 is registered in the group convergence polygonal line. The group convergence polygonal line 50 to be registered does not need to have a line (graph) shape, but only needs to indicate the correlation between the connection distance Lc and the remaining group number Gr. For example, the group convergence polygonal line 50 can be implemented by numerical data in which the connection distance Lc and the remaining group number Gr are associated with each other. Further, the heterogeneity index F calculated by the heterogeneity index calculation unit 106 is registered in the heterogeneity index.

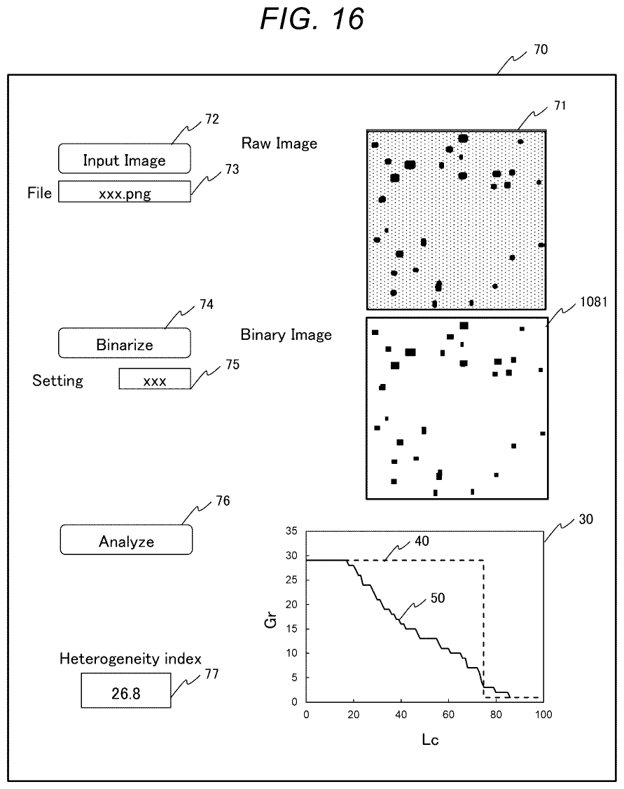

When the heterogeneity index F is calculated, the display data generation unit 107 generates display data according to the heterogeneity information 1084. For example, the heterogeneity index F and the group convergence graph 30 are generated. Then, the output unit 102 outputs the generated display data. For example, the display data is displayed on a GUI screen. The GUI screen will be described later with reference to FIG. 16. The heterogeneity information 1084 may be treated as individual information for each of the items.

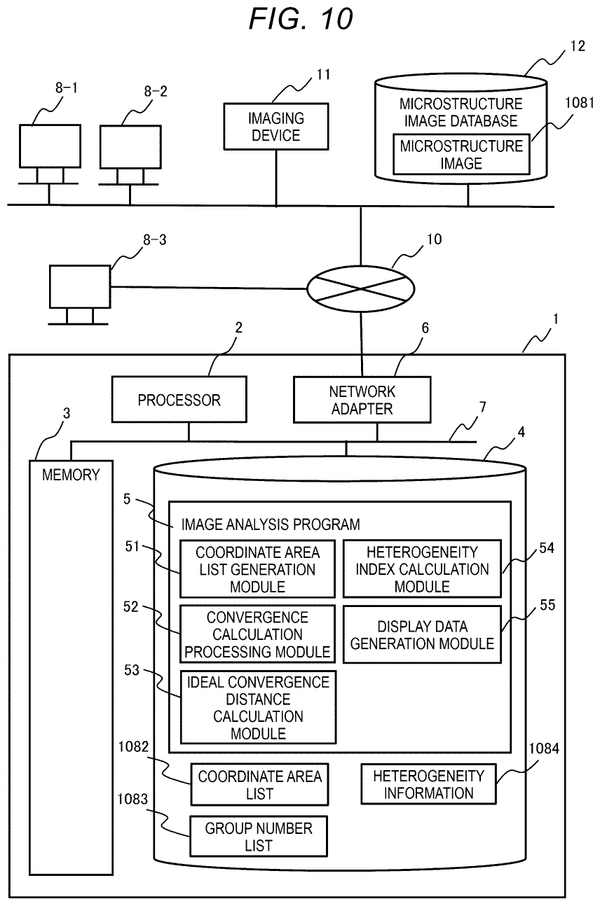

Next, an implementation example of the image analysis device 1 will be described. FIG. 10 is a hardware configuration diagram of the image analysis device 1 according to Embodiment 1. The image analysis device 1 according to Embodiment 1 is implemented by a server, which is an example of a computer, in particular, a cloud. As shown in FIG. 10, the image analysis device 1 includes a processor 2, a memory 3, a storage device 4, and a network adapter 6, which are connected to each other via a system bus 7 serving as a communication path.

First, the processor 2 can be implemented by a processing device such as a CPU, and performs calculation according to an image analysis program 5 stored in the storage device 4 to be described later. The image analysis program 5 will be described later.

The memory 3 and the storage device 4 correspond to the storage unit 108 in FIG. 1. In the memory 3, the image analysis program 5 stored in the storage device 4 and information used for processing in the processor 2 are loaded. The storage device 4 can be implemented by a so-called storage, and stores the image analysis program 5, the coordinate area list 1082, the group number list 1083, and the heterogeneity information 1084.

In Embodiment 1, the microstructure image 1081 may be stored in a microstructure image database 12 that is a separate device from the image analysis device 1, and may be stored in the storage device 4. The storage device 4 may be implemented by various storage media such as an external hard disk drive (HDD), a solid state drive (SSD), and a memory card. Further, the coordinate area list 1082, the group number list 1083, and the heterogeneity information 1084 may be stored in a device that is different from the image analysis device 1, such as the microstructure image database 12. In this way, the image analysis program 5, the coordinate area list 1082, the group number list 1083, and the heterogeneity information 1084 are stored in a storage medium represented by the storage device 4.

The network adapter 6 has a communication function of communicating with other devices via a network 10. The other devices include an imaging device 11, the microstructure image database 12, and terminal devices 8. In this way, since the network adapter 6 inputs and outputs an instruction or various types of information to and from other devices, the network adapter 6 has functions of the input unit 101 and the output unit 102 in FIG. 1.

In the implementation example in FIG. 10, since each of the terminal devices 8 receives an input from a user and performs output such as display of the display data, the terminal device 8 also has functions of the input unit 101 and the output unit 102 in FIG. 1. However, an input device or a display device may be provided in the image analysis device 1 and may be used as an interface with the user.

Here, the image analysis program 5 includes a coordinate area list generation module 51, a convergence calculation processing module 52, an ideal convergence distance calculation module 53, a heterogeneity index calculation module 54, and a display data generation module 55. Each of these modules may be implemented by an individual program or a combination of some of these modules.

A configuration shown in FIG. 1 executing functions the same as those of the modules is as follows.

The coordinate area list generation module 51 corresponds to the coordinate area list generation unit 103.

The convergence calculation processing module 52 corresponds to the convergence calculation processing unit 104.

The ideal convergence distance calculation module 53 corresponds to the ideal convergence distance calculation unit 105.

The heterogeneity index calculation module 54 corresponds to the heterogeneity index calculation unit 106.

The display data generation module 55 corresponds to the display data generation unit 107.

Accordingly, the processor 2 executes processing of the coordinate area list generation unit 103, the convergence calculation processing unit 104, the ideal convergence distance calculation unit 105, the heterogeneity index calculation unit 106, and the display data generation unit 107 according to the image analysis program 5. Each of the modules may be configured with an individual program.

The imaging device 11 captures an image of a cross section or the like of a composition such as a material to acquire the microstructure image 1081. The imaging device 11 can be implemented by, for example, a microscope such as an optical microscope or an electron microscope. The imaging device 11 registers the captured microstructure image 1081 in the microstructure image database 12. The microstructure image database 12 stores the microstructure image 1081 captured by the imaging device 11. The imaging device 11 and the microstructure image database 12 can be implemented as an in-company system used and managed by a company or the like that analyzes the composition. The in-company system includes a terminal device 8-1 and a terminal device 8-2, which are connected to each other via an in-company network such as an intranet.

The terminal device 8-1 and the terminal device 8-2 can be implemented by a computer such as a PC or a tablet, and each includes an input device and a display device. Accordingly, the terminal device 8-1 and the terminal device 8-2 are operated by the user and display the display data. The user can use the terminal device 8-1 and the terminal device 8-2 to use the image analysis device 1 that is implemented as an external device such as a cloud system via the network 10.

The terminal device 8 is not limited to being implemented as an in-company system, and may be implemented as a terminal device 8-3 connected to the network 10. Although the image analysis device 1 shown in FIG. 10 can be used by user entities in a plurality of companies or the like, the image analysis device 1 may be limitedly used by a specific use entity such as an in-company system, and a function of the image analysis device 1, in particular, the image analysis program 5 may be implemented in a PC or the like. Further, the terminal device 8 may be directly connected to the image analysis device 1 without using the network 10. Further, in Embodiment 1, a microscope device including a microscope that is the imaging device 11 and the image analysis device 1 may be implemented. Alternatively, the microscope device may be provided with functions of the microscope and the image analysis device 1. In this case, the image analysis program 5 is installed in the microscope device, and the processing is executed according to the image analysis program 5. The implementation example of Embodiment 1 has been described above.

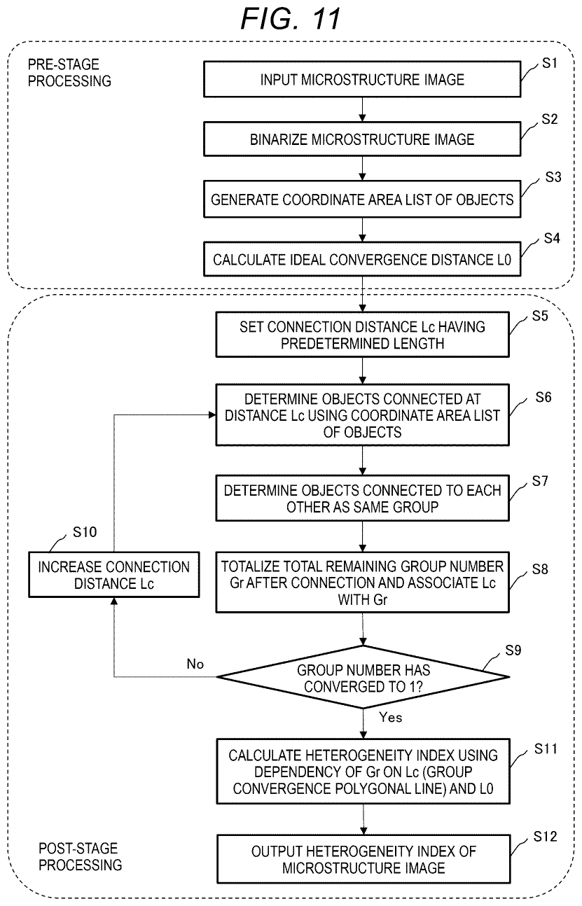

Next, a series of processing according to Embodiment 1 will be described with reference to a flowchart. FIG. 11 is a flowchart showing an image analysis processing flow according to Embodiment 1. As shown in FIG. 11, the image analysis processing flow according to Embodiment 1 includes pre-stage processing and post-stage processing. Hereinafter, the processing will be described. At this time, a processing entity will be described with reference to FIG. 1. Since details of steps are already described, description thereof is omitted.

First, in the pre-stage processing, the microstructure image 1081 is processed, and the coordinate area list 1082, and the ideal convergence distance are calculated. Details of the pre-stage processing will be described below. First, the input unit 101 receives the microstructure image 1081 according to an operation from a user (step S1). For example, the input unit 101 reads the microstructure image 1081 from the storage unit 108.

Then, the coordinate area list generation unit 103 binarizes the received microstructure image 1081 (step S2). Then, the coordinate area list generation unit 103 generates the coordinate area list 1082 of the objects 20 based on the binarized microstructure image (step S3). Then, the ideal convergence distance calculation unit 105 calculates the ideal convergence distance L0 (step S4). The pre-stage processing has been described above. The pre-stage processing and the post-stage processing may be executed consecutively or discontinuously in time.

In the subsequent post-stage processing, the heterogeneity information 1084 is generated. Details of the post-stage processing will be described below. First, the convergence calculation processing unit 104 sets the connection distance Lc having a predetermined length (step S5). The connection distance Lc can be determined in any manner. For example, the connection distance Lc may be determined according to a composition to be analyzed, or may be determined using a learning result as a past analysis result.

Then, the convergence calculation processing unit 104 determines, using the coordinate area list 1082, the objects 20 connected at the connection distance Lc (step S6). Then, the convergence calculation processing unit 104 determines that the objects 20 connected to each other belong to the same group (step S7).

Then, the convergence calculation processing unit 104 totalizes the remaining group number Gr after the connection and associates the connection distance Lc with the remaining group number Gr (step S8). Here, this processing flow is repeatedly executed according to a determination result in step S9. Accordingly, the associated connection distance Lc in the second and subsequent processing is a value obtained by adding the connection distance Lc set in step S5 and the connection distance Lc (accumulated value) increased in step S10. In step S8, group convergence polygonal lines 50 are generated one after another. This means that the correlation between the connection distance Lc and the remaining group number Gr is specified in this step.

Then, the convergence calculation processing unit 104 determines whether the remaining group number Gr has converged to 1 (step S9). As a result, when the remaining group number Gr does not converge to 1, that is, when Gr>1 (No), the processing proceeds to step S10. When the remaining group number Gr has converged to 1 (Yes), the processing proceeds to step S11.

Then, the convergence calculation processing unit 104 further increases the connection distance Lc and returns to step S6. The above loop is repeated until the group number Gr=1, and data of the group convergence polygonal line 50 is generated. Then, the heterogeneity index calculation unit 106 calculates the heterogeneity index F based on the group convergence polygonal line 50 and the ideal convergence distance L0 (step S11). As a result, the heterogeneity information 1084 is generated. Here, the heterogeneity index calculation unit 106 compares the group convergence polygonal line 50 with the ideal convergence line 40 that is generated based on the ideal convergence distance L0, and calculates the heterogeneity index F using the difference therebetween.

Then, the display data generation unit 107 generates the display data according to the heterogeneity information 1084. Then, the output unit 102 outputs the generated display data (step S12).

The post-stage processing has been described above, but another processing of steps S5 to S10 will be described. In the above processing, the connection distance Lc increased in step S10 is constant, but the connection distance Lc may not be constant. For example, the Lc at the beginning of the processing may be set larger, or vice versa. Further, the connection distance Lc may be changed according to the remaining group number Gr as follows. Further, as another example, processing of reducing the increase width of the connection distance Lc in a location in which the remaining group number Gr decreases more will be described.

The convergence calculation processing unit 104 executes steps S5 to S10 using the connection distance Lc set as an initial value. Then, when the group number has converged to 1 in step S9, the convergence calculation processing unit 104 calculates each of differences between the remaining group numbers Gr in adjacent processing. In response to this, the convergence calculation processing unit 104 subdivides the connection distance Lc and executes the processing from step S6 and subsequent steps for processing in which the difference is large among the differences, that is, processing in which the remaining group number Gr decreases more. Here, the remaining group number Gr decreasing more indicates a high-ranking difference or a difference equal to or larger than a threshold value among the differences. The subdivision means dividing the connection distance Lc by an integer. The integer may be determined according to a magnitude of the difference.

Further, steps S6 to S10 may be executed as follows. The convergence calculation processing unit 104 executes steps S6 and S7 using the connection distance Lc set as the initial value. Then, in the second and subsequent processing, the convergence calculation processing unit 104 calculates a difference between the remaining group number Gr in the immediately preceding processing and the remaining group number Gr in the processing. When the difference is equal to or larger than a threshold value, that is, when a decrease number is equal to or larger than the threshold value, the convergence calculation processing unit 104 subdivides the connection distance Lc and executes the processing (steps S6 and S7) again. In Embodiment 1, the remaining group number Gr in the convergence determination in step S9 is set to 1, but is not limited thereto, and any numerical value smaller than the number N of the objects 20 may be used. That is, in step S9, the convergence calculation processing unit 104 may determine whether the remaining group number Gr has converged to a value that is equal to or larger than 1 and less than N. This numerical value may be set by the user in any manner. This also applies to Embodiment 2 to be described later. The processing flow of Embodiment 1 has been described above, and a processing result according to Embodiment 1 will be described.

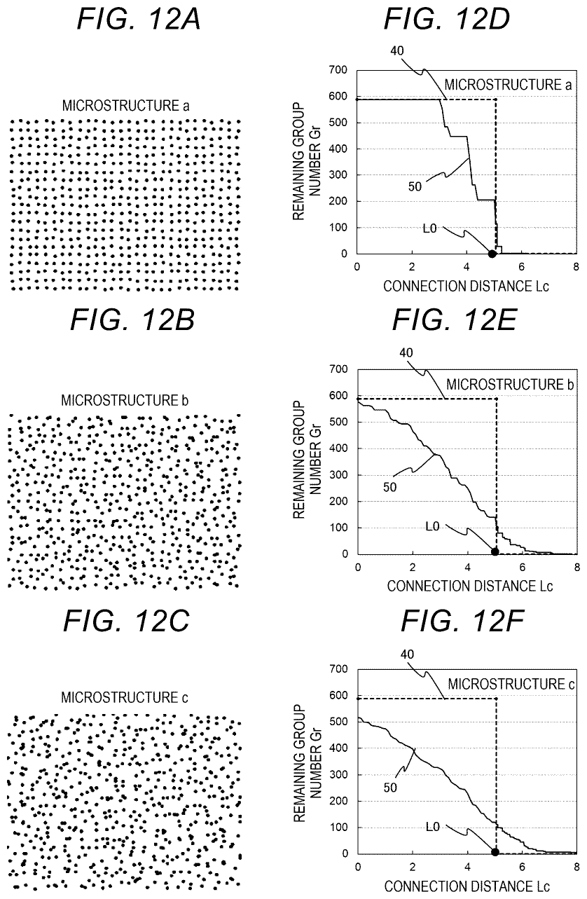

FIGS. 12A to 12F are diagrams each showing an example of the analysis result according to Embodiment 1. FIGS. 12A to 12C show pseudo data of microstructure images for verifying validity of the analysis method according to Embodiment 1. The pseudo data is generated by arranging a large number of particles in a grid shape and then randomly varying each of particle coordinates within a predetermined variation range. In FIGS. 12A to 12C, the variation range of the particle coordinate decreases in an order of a microstructure a, a microstructure b, and a microstructure c.

That is, the microstructure images are gradually non-uniform in this order. FIGS. 12D to 12F show group convergence graphs each showing the dependency of the group number on the connection distance Lc, which is obtained by analyzing the respective images of the microstructure a, the microstructure b, and the microstructure c. According to the group convergence graphs showing the analysis results, it is understood that as the microstructure is more non-uniform, the group convergence polygonal line 50 is more inclined, and a deviation between the group convergence polygonal line 50 and the ideal convergence line 40 is larger.

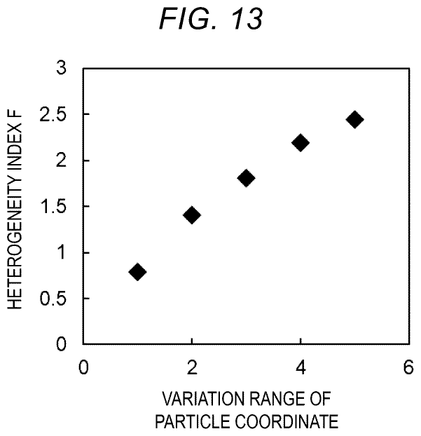

Next, the heterogeneity index F is calculated based on the group convergence graphs using the above method, and a graph obtained by plotting a relation between the heterogeneity index F and a variation range of the particle coordinates is shown in FIG. 13. As is clear from FIG. 13, it can be understood that the heterogeneity index F tends to increase uniformly as the variation range of the particle coordinates increases. As described above, by using the analysis method according to Embodiment 1, it is possible to appropriately quantify a bias in an arrangement of objects in a microstructure image.

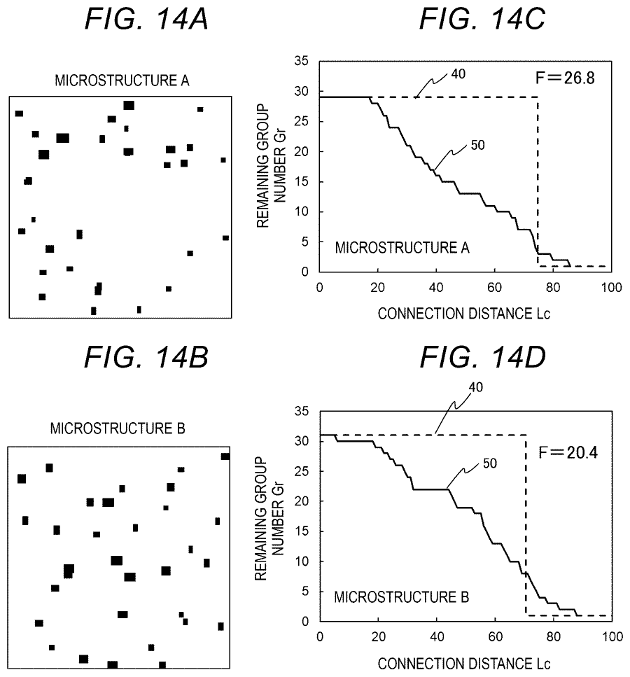

FIGS. 14A to 14D each show another example of the analysis result. FIGS. 14A and 14B show a microstructure A and a microstructure B, which are microstructure images analyzed in Embodiment 1. In the microstructure A and the microstructure B, objects having different areas are randomly dispersed.

The microstructure A is a microstructure which has a bias and in which the arrangement of the objects is more biased than that of the microstructure B. Group convergence graphs showing the dependency of the group number on the connection distance Lc, which are obtained by analyzing each of the images, are shown in FIGS. 14C and 14D. When the group convergence graphs are compared with each other, the deviation between the group convergence polygonal line 50 and the ideal convergence line 40 is larger in the microstructure A having the bias than that in the microstructure B. The heterogeneity index F of the microstructure A is 26.8, and the heterogeneity index F of the microstructure B is 20.4. As described above, by using the analysis method according to Embodiment 1, it is possible to appropriately quantify heterogeneity of a microstructure including an area variation in addition to an arrangement variation.

### Embodiment 2

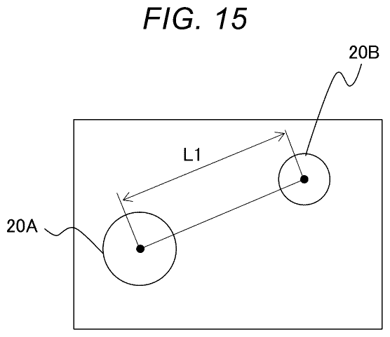

Next, Embodiment 2 will be described. A basic configuration and an analysis method according to Embodiment 2 are the same as those according to Embodiment 1. In Embodiment 1, the heterogeneity index F is calculated using the areas of the objects, but in Embodiment 2, the heterogeneity index F is calculated without using the areas of the objects. Therefore, Embodiment 2 is different from Embodiment 1 in calculation for the object-to-object distance and a method of calculating the ideal convergence distance L0. FIG. 15 is a diagram showing calculation for the object-to-object distance according to Embodiment 2. The convergence calculation processing unit 104 calculates a distance between coordinates of centers of gravity of the object 20A and the object 20B as the object-to-object distance L1. In Embodiment 2, the convergence calculation processing unit 104 calculates the ideal convergence distance L0 according to the following (Formula 3).

$$L 0 = \sqrt{W \cdot H / N} \qquad ( Formula 3 )$$

Here, W represents the width of the microstructure image 1081 of targets, H represents the height of the microstructure image 1081 of the targets, and N represents the number of the objects in the microstructure image 1081 of the targets. The ideal convergence distance L0 is uniquely determined using (Formula 3) regardless of subjectivity. In Embodiment 2, the object-to-object distance L1 in Embodiment 1 and Embodiment 2 may be the shortest distance of outer edges of the objects. That is, the convergence calculation processing unit 104 assumes that the object is a circle, and calculates, as the object-to-object distance, a distance obtained by subtracting radii of the objects from the distance between the centers of gravity.

In Embodiment 2, the convergence calculation processing unit 104 calculates the group convergence polygonal line 50 using the object-to-object distance shown in FIG. 15 in a method the same as that in Embodiment 1. Further, the heterogeneity index calculation unit 106 calculates the heterogeneity index F according to (Formula 2) using the relation between the group convergence polygonal line 50 and the ideal convergence line 40 calculated using (Formula 3).

In Embodiment 1 and Embodiment 2, (Formula 2) is used as the calculation formula for the heterogeneity index F, but the method of calculating the heterogeneity index is not limited thereto. For example, when micro homogeneity between objects is emphasized as a microstructure feature to be focused on, a feature in which the connection distance is small may be emphasized to calculate the heterogeneity index F using only a region Sd1 shown in FIG. 8. Alternatively, when macro homogeneity is emphasized, the heterogeneity index F may be calculated using only a region Sd2 in FIG. 8. Alternatively, it is also possible to calculate a desired heterogeneity index F according to a purpose of the user using a portion of each of the regions Sd1 and the Sd2 in a combination thereof.

In Embodiment 1 and Embodiment 2, the ideal convergence distance L0 is calculated on the assumption that the objects 20 are arranged at equal intervals in a square grid as shown in (c) in FIG. 7, but the method of calculating the ideal convergence distance L0 is not limited thereto. For example, a situation in which regular triangular regions having the same area and each including one object 20 are arranged without a gap can be considered as an ideal dispersion state. In this case, the ideal convergence distance L0 when the area of the object 20 is not taken into consideration is a distance between centers of gravity of two adjacent regular triangles, and can be expressed by the following (Formula 4).

$$L 0 = \frac{2 \sqrt{W \cdot H / N}}{\sqrt[4]{27}} \qquad ( Formula 4 )$$

The ideal convergence distance L0 when the area of the object 20 is taken into consideration in the case of a square grid can be expressed by the following (Formula 5).

$$L 0 = \frac{2 \sqrt{W \cdot H / N}}{\sqrt[4]{27}} - 2 \sqrt{\frac{S a}{N π}} \qquad ( Formula 5 )$$

In (Formula 4) and (Formula 5), W represents the width of the microstructure image 1081 of the targets, H represents the height of the microstructure image 1081 of the targets, N represents the number of the objects in the microstructure image 1081 of the targets, Sa represents the total area of the objects, and IT represents the circumference ratio.

Next, a GUI in Embodiment 1 and Embodiment 2 will be described. Here, the GUI that displays an analysis result to a user in response to receiving an operation from the user will be described. FIG. 16 shows an example of a GUI screen 70 in Embodiment 1 and Embodiment 2. The GUI screen 70 is displayed on the output unit 102 in FIG. 1 or a display device of the terminal device 8 in FIG. 10.

Hereinafter, contents and functions of the GUI screen 70 will be described in accordance with an analysis processing process performed by the user. First, when the user presses an image input button 72, a captured image file to be analyzed is designated from the microstructure image 1081 stored in the storage unit 108. A file name is displayed in an input image file name display field 73, and a selected input image 71 is also displayed on the GUI screen 70. In general, the input image 71 at this time is often a color image or a grayscale image captured by using an optical microscope or an electron microscope.

Subsequently, when the user presses a binarization processing execution button 74, a binarization processing unit to be described later converts the input image 71 into a black-and-white binary image. The binary image is the microstructure image 1081 described in Embodiment 1 and Embodiment 2 and is displayed on the GUI screen 70. The binarization processing may be executed by automatically calculating a threshold value such as Otsu's binarization method (discriminant analysis method) or may be executed by setting a threshold value of a luminance level or a color tone by a user. In the latter case, the user inputs a setting value such as the threshold value necessary for the binarization processing to a parameter setting field 75, and then presses the binarization processing execution button 74 to start the processing.

Thereafter, when the user presses an analysis execution button 76, the image analysis device 1 executes heterogeneity analysis. When the analysis is completed, the output unit 102 displays, as display data, the group convergence graph 30 that is an analysis result on the GUI screen 70. The group convergence polygonal line 50 and the ideal convergence line 40 in the group convergence graph 30 are displayed. The calculated heterogeneity index F is also displayed in a display field 77. As a result, the user can determine the dispersibility and the like of the objects 20 while checking the image. A part of the items of the GUI screen 70 may be displayed.

The embodiments in the invention have been described above, but the invention is not limited thereto. In particular, the processing executed by the convergence calculation processing unit 104 also includes generating, for each of a plurality of connection distances, a remaining group including objects that can be to connected to each other at the connection distance. Further, the processing executed by the convergence calculation processing unit 104 can also be expressed as grouping objects within a range of each of the plurality of connection distances. Further, the connection distance correlation information also includes a convergence curve indicating a change in group number of the remaining groups for each of the connection distances. Further, in each embodiment, the heterogeneity index F is calculated by comparing the ideal convergence line 40 with the group convergence polygonal line 50. This is an example of the calculation for the heterogeneity index F, and the heterogeneity index F can be calculated based on the connection distance correlation information and the ideal convergence distance L0.

Further, the image analysis device 1 according to each embodiment may be provided with a binarization processing unit that adjusts a contrast of the microstructure image 1081 and that outputs a binary image in which objects and another component are represented in black and white. In this case, the coordinate area list generation unit 103 generates, as the coordinate area list 1082, a list including an area and a coordinate of a center of gravity of each of the objects 20 based on the binary image.

What is claimed is:

1. An image analysis device for analyzing an arrangement of objects in a microstructure image of a composition, the image analysis device comprising:
an ideal convergence distance calculation unit configured to calculate an ideal convergence distance indicating a distance between the objects in an ideal state of the arrangement of the objects;
a convergence calculation processing unit configured to generate, for each of a plurality of connection distances, a plurality of remaining groups in each of which the objects are connectable to each other at the connection distance, and generate connection distance correlation information indicating a correlation between a group number of the generated remaining groups and the connection distance;
a heterogeneity index calculation unit configured to calculate a heterogeneity index indicating a bias in the arrangement of the objects based on the ideal convergence distance and the connection distance correlation information; and
an output unit configured to output display data according to the heterogeneity index.

2. The image analysis device according to claim 1, wherein
the convergence calculation processing unit calculates an object-to-object distance indicating a distance between the objects, and sets, as the remaining group, objects having an object-to-object distance shorter than the connection distance.

3. The image analysis device according to claim 2, wherein
the object-to-object distance is a distance between centers of gravity of two of the objects whose distances are measured.

4. The image analysis device according to claim 1, wherein
the convergence calculation processing unit performs the calculation using Formula 3 where L0 represents the ideal convergence distance, W represents a width of the microstructure image, H represents a height of the microstructure image, and N represents the number of objects
$$L 0 = \sqrt{W \cdot H / N} . \qquad ( Formula 3 )$$

5. The image analysis device according to claim 2, wherein
the convergence calculation processing unit assumes that the object is a circle, and calculates, as the object-to-object distance, a distance obtained by subtracting radii of the objects from a distance between centers of gravity of the objects.

6. The image analysis device according to claim 2, wherein
the convergence calculation processing unit performs the calculation using Formula 5 where L0 represents the ideal convergence distance, W represents a width of the microstructure image, H represents a height of the microstructure image, N represents the number of objects, Sa represents a total area of the objects, and IT represents a circumference ratio
$$L 0 = \frac{2 \sqrt{W \cdot H / N}}{\sqrt[4]{27}} - 2 \sqrt{\frac{S a}{N π}} . \qquad ( Formula 5 )$$

7. The image analysis device according to claim 1, wherein
the ideal convergence distance calculation unit generates an ideal convergence line using the ideal convergence distance,
the convergence calculation processing unit generates a group convergence polygonal line using the connection distance correlation information, and
the heterogeneity index calculation unit calculates the heterogeneity index using a difference between the group convergence polygonal line and the ideal convergence line.

8. The image analysis device according to claim 7, wherein
the heterogeneity index calculation unit calculates, as the heterogeneity index, Sd/N obtained by dividing an area Sd surrounded by the group convergence polygonal line and the ideal convergence line by the number N of the objects in a group convergence graph in which the ideal convergence line is drawn to be superimposed on the group convergence polygonal line.

9. The image analysis device according to claim 1, further comprising:
a binarization processing unit configured to adjust a contrast of the microstructure image and output a binary image in which the objects and another component are represented in black and white; and
a coordinate area list generation unit configured to generate, based on the binary image, a coordinate area list which is a list including an area and a coordinate of a center of gravity of the object.

10. The image analysis device according to claim 1, wherein
the output unit displays, on a GUI display screen, the microstructure image and a group convergence graph including the ideal convergence distance and the connection distance correlation information.

11. A storage medium that stores an image analysis program for causing an image analysis device, which is a computer and is used for analyzing an arrangement of objects in a microstructure image of a composition, to function as:
an ideal convergence distance calculation unit configured to calculate an ideal convergence distance indicating a distance between the objects in an ideal state of the arrangement of the objects;
a convergence calculation processing unit configured to generate, for each of a plurality of connection distances, a plurality of remaining groups in each of which the objects are connectable to each other at the connection distance, and generate connection distance correlation information indicating a correlation between a group number of the generated remaining groups and the connection distance;
a heterogeneity index calculation unit configured to calculate a heterogeneity index indicating a bias in the arrangement of the objects based on the ideal convergence distance and the connection distance correlation information; and
an output unit configured to output display data according to the heterogeneity index.

12. A microscope device comprising:
the image analysis device according to claim 1.
